(19) United States
(12) Patent Application Publication
(10) Pub. No.: US 2024/0010014 A1
(43) Pub. Date: Jan. 11, 2024

(54) PRINTING CASSETTE INCLUDING GUIDE CASE HAVING ENGAGEMENT SURFACE PROTRUDING FROM SIDE SURFACE, AND PRINTING DEVICE USING THE SAME

(71) Applicant: BROTHER KOGYO KABUSHIKI KAISHA, Nagoya (JP)

(72) Inventors: Shinji UKAI, Kiyosu (JP); Kentaro MURAYAMA, Kasugai (JP); Yuya TAGAMI, Nagoya (JP)

(21) Appl. No.: 18/472,827

(22) Filed: Sep. 22, 2023

Related U.S. Application Data
(63) Continuation of application No. PCT/JP2022/011552, filed on Mar. 15, 2022.

(30) Foreign Application Priority Data
Mar. 24, 2021 (JP) 2021-050351

(51) Int. Cl. B41J 15/04; B41J 3/407

(52) U.S. Cl. CPC B41J 15/044; B41J 3/4075

(57) ABSTRACT

There is provided a printing cassette attachable to a printer body including a cassette accommodating portion provided with a first engaging portion. The printing cassette includes a printing tape roll configured of a printing tape, and a guide case arranged at a different position from the printing tape roll in a first direction parallel to a center axis of the printing tape roll. The guide case has a guide portion configured to guide the printing tape paid out from the printing tape roll, a first side surface positioned to overlap with the guide portion in a direction perpendicular to the first direction, and a first engagement surface engageable with the first engaging portion. The first engagement surface extends from the first side surface to cross therewith.

### REFERENCE TO RELATED APPLICATIONS

This is a by-pass continuation application of International Application No. PCT/JP2022/011552 filed Mar. 15, 2022 claiming priority from Japanese Patent Application No. 2021-050351 filed Mar. 24, 2021. The entire contents of the International Application and the priority application are incorporated herein by reference.

### BACKGROUND ART

In a printing device configured to perform printing on a printing tape, a cassette accommodating the printing tape is attached to and detached from a printer body for replacement and supply of the printing tape. The cassette has an engagement surface configured to be engaged with an engaging portion of the printer body for positioning the cassette relative to the printer body.

In such a type of cassette, a structure for conveying the printing tape to a position displaced in an axial direction of a tape roll inside the cassette is conceivable.

### DESCRIPTION

According to the cassette in which the printing tape is conveyed in the axial direction of the tape roll, in a case where the engagement surface is positioned to overlap with the tape roll in a radial direction thereof, a degree of freedom in design of the size of a case accommodating the tape roll therein may be lowered. As a result, the cassette may become bulky in size.

In view of the foregoing, according to one aspect, it is an object of the present disclosure to provide a printing cassette capable of suppressing enlargement in size of the cassette.

In order to attain the above and other object, according to one aspect, the present disclosure provides a printing cassette attachable to a printer body including a cassette accommodating portion provided with a first engaging portion. The printing cassette includes: a printing tape roll configured of a printing tape; and a guide case arranged at a position different from a position of the printing tape roll in a first direction parallel to an axial direction of the printing tape roll.

The guide case has: a guide portion configured to guide the printing tape paid out from the printing tape roll; a first side surface overlapped with the guide portion in a direction perpendicular to the first direction; and a first engagement surface engageable with the first engaging portion. The first engagement surface extends from the first side surface and crosses the first side surface.

According to another aspect, the present disclosure also provides a printing device including: a printer body including a cassette accommodating portion provided with a first engaging portion; and the printing cassette.

With these structures, the first engagement surface is arranged to be displaced from the printing tape roll in the axial direction of the printing tape roll. Accordingly, a degree of freedom in designing a size of the guide case is less likely to be lowered due to the arrangement of the first engagement surface. As a result, an increase in size of the printing cassette can be restrained.

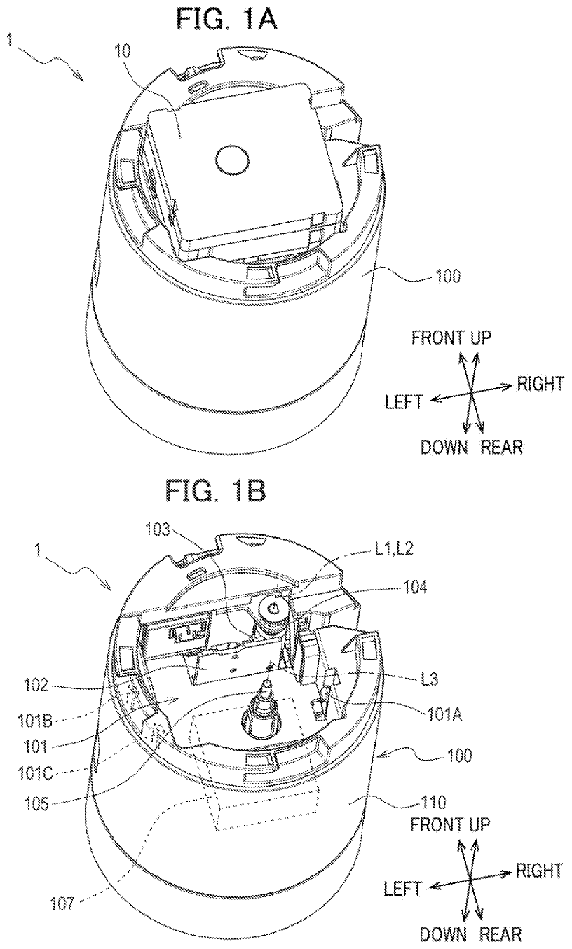

FIG. 1A is a schematic perspective view of a printing device according to one embodiment.

FIG. 1B is a schematic perspective view of a printer body of the printing device of FIG. 1A.

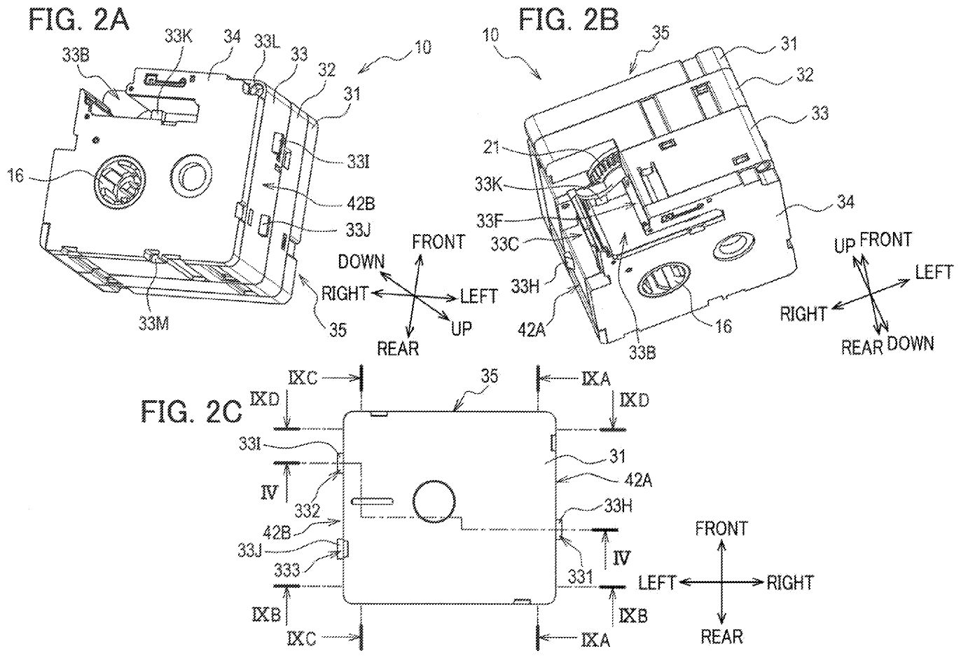

FIG. 2A is a schematic perspective view of a printing cassette in the printing device of FIG. 1A.

FIG. 2B is another schematic perspective view of the printing cassette in the printing device of FIG. 1A.

FIG. 2C is a schematic plan view of the printing cassette of FIG. 2A.

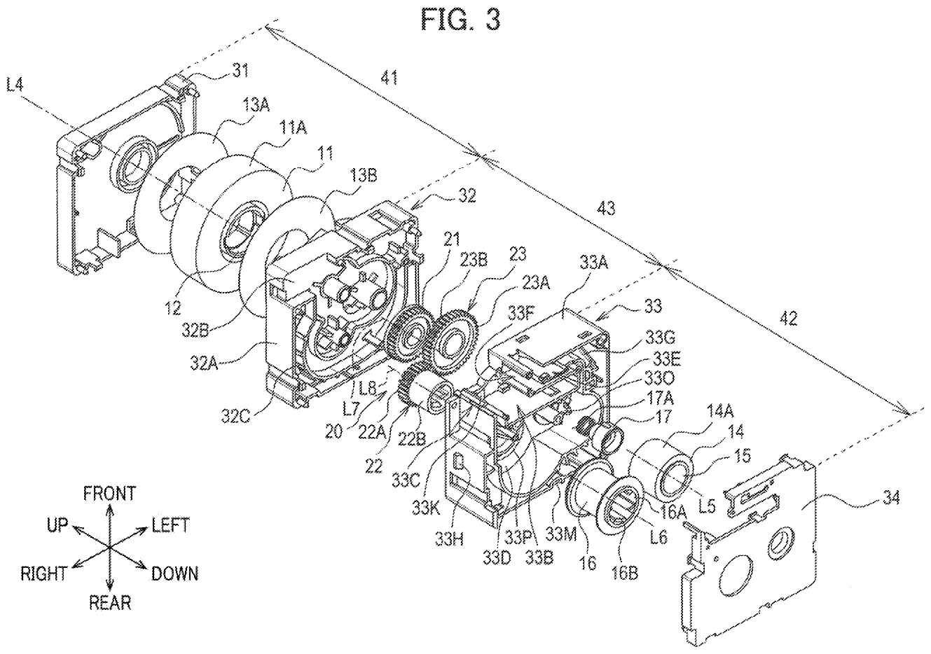

FIG. 3 is an exploded perspective view of the printing cassette of FIG. 2A.

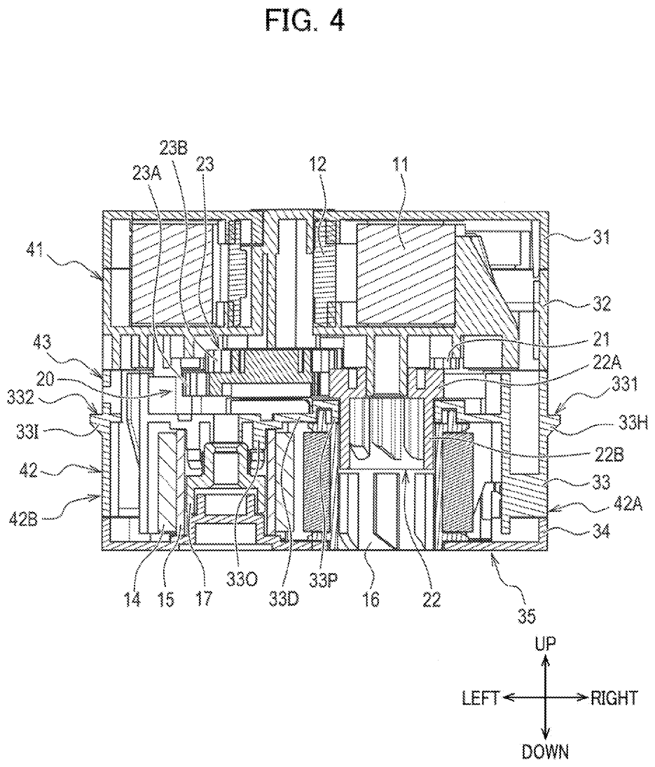

FIG. 4 is a cross-sectional view taken along a line IV-IV in FIG. 2C.

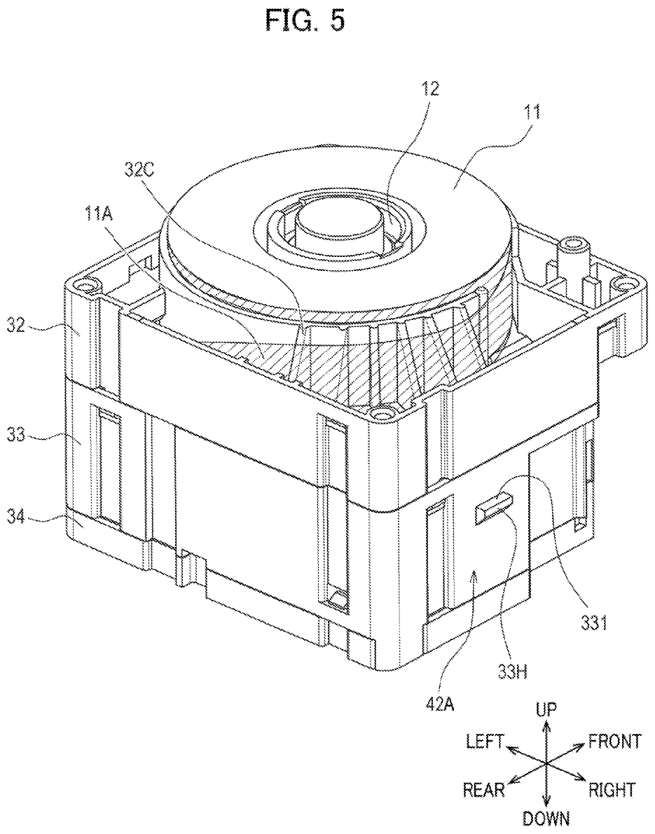

FIG. 5 is a schematic perspective view of the printing cassette of FIG. 2A in a state where a first cover part is removed.

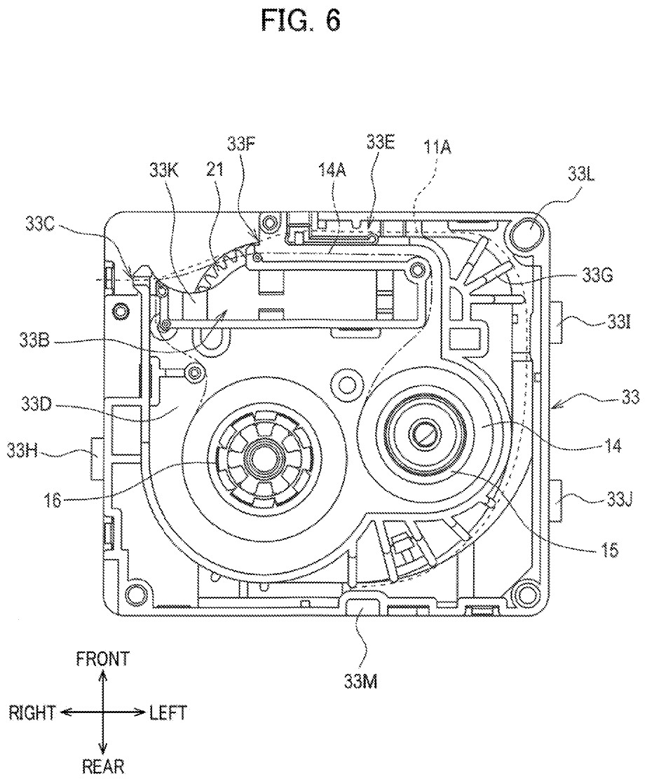

FIG. 6 is a schematic view illustrating travel routes of a printing tape and an ink ribbon in the printing cassette of FIG. 2A.

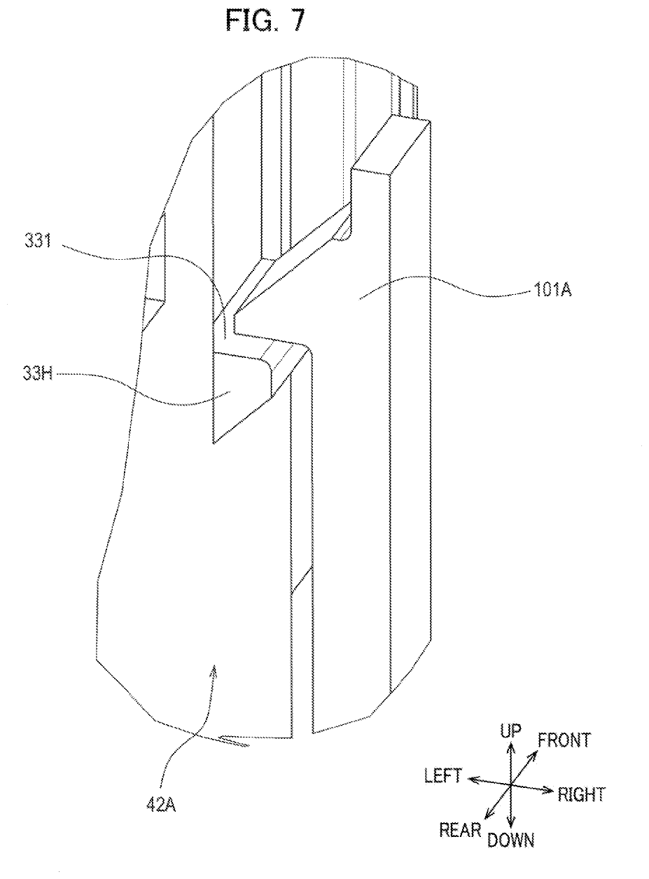

FIG. 7 is a partially-enlarged schematic perspective view illustrating an engagement state of a first engaging portion with a first engagement surface.

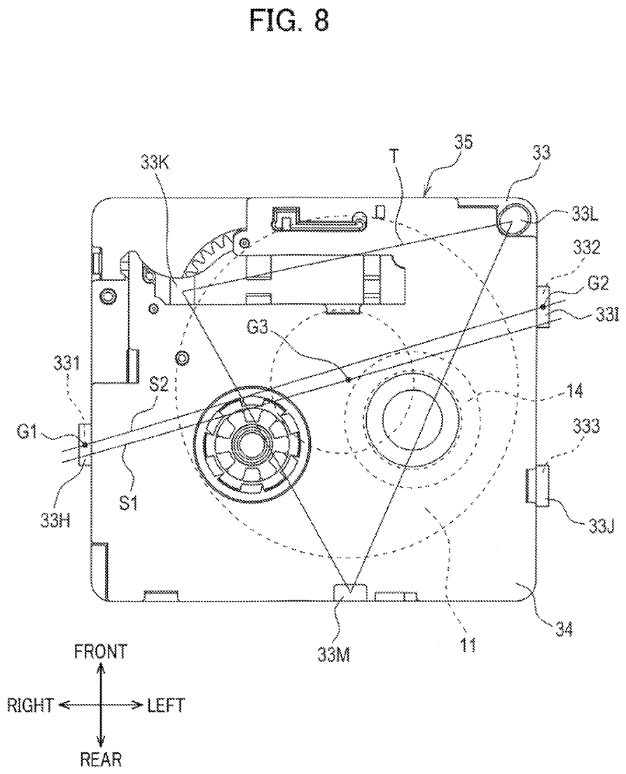

FIG. 8 is a schematic bottom view of the printing cassette of FIG. 2A.

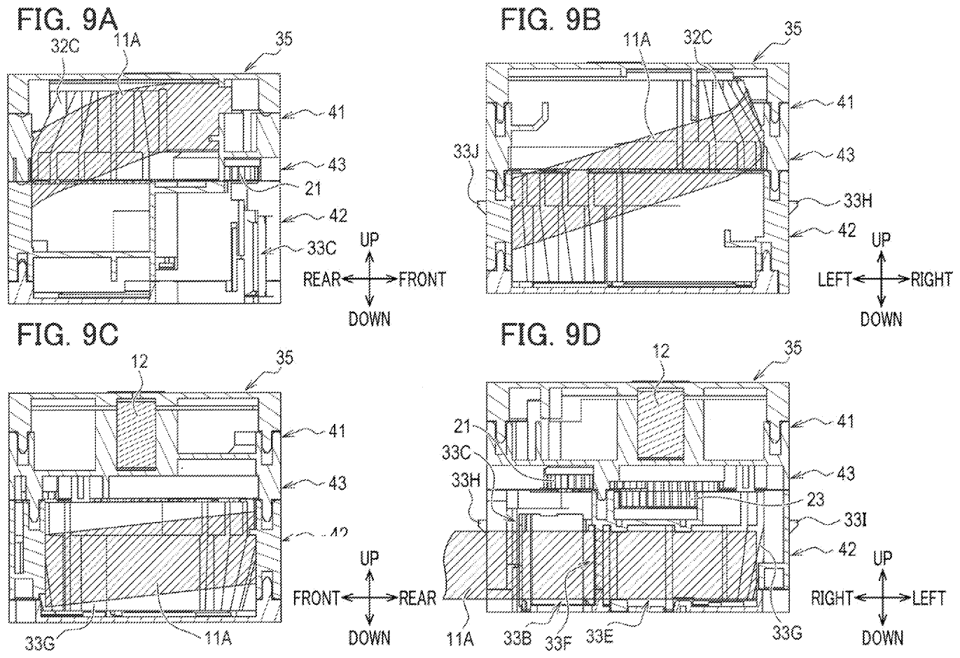

FIG. 9A is a cross-sectional view taken along a line IXA-IXA in FIG. 2C.

FIG. 9B is a cross-sectional view taken along a line IXB-IXB in FIG. 2C.

FIG. 9C is a cross-sectional view taken along a line IXC-IXC in FIG. 2C.

FIG. 9D is a cross-sectional view taken along a line IXD-IXD in FIG. 2C.

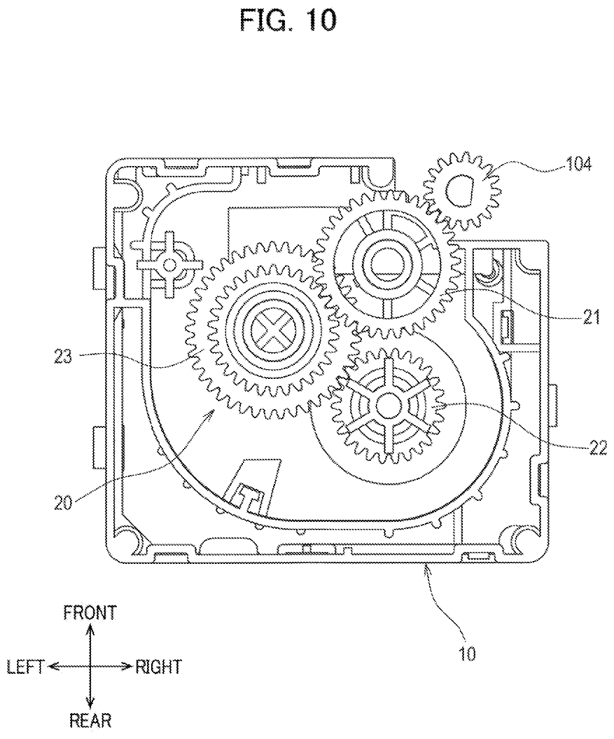

FIG. 10 is a schematic view illustrating an engaging state between an output gear and a platen gear in the printing device of FIG. 1A.

### 1. FIRST EMBODIMENT

[1-1. Structure]

A printing device 1 illustrated in FIG. 1A includes a printing cassette 10 and a printer body 100. The printing device 1 is configured to perform printing on a printing tape 11A.

In the present embodiment, an axial direction of an output gear 21 will be referred to as an up-down direction, a direction perpendicular to the up-down direction and coincident with a conveying direction of the printing tape 11A at a discharge opening 33C will be referred to as a left-right direction, and a direction perpendicular to both of the up-down direction and the left-right direction will be referred to as a front-rear direction.

<Printer Body>

As illustrated in FIG. 1B, the printer body 100 includes a cassette accommodating portion 101, a printing head 102, a platen roller 103, a platen gear 104, a drive shaft 105, a drive source 107, and a housing 110.

(Cassette Accommodating Portion)

The cassette accommodating portion 101 is a recessed portion to which the printing cassette 10 is attachable. The cassette accommodating portion 101 has a function to fix the printing cassette 10 in position. The cassette accommodating portion 101 is provided in the housing 110.

The cassette accommodating portion 101 includes a first engaging portion 101A, a second engaging portion 101B, and a third engaging portion 101C. The first engaging portion 101A, the second engaging portion 101B, and the third engaging portion 101C are configured to be engaged with a case 35 of the printing cassette 10 inserted in the cassette accommodating portion 101.

The first engaging portion 101A, the second engaging portion 101B, and the third engaging portion 101C are respectively hooks extending in the up-down direction inside the cassette accommodating portion 101 and engageable with the case 35 from the above.

(Printing Head)

The printing head 102 is positioned inside the cassette accommodating portion 101. The printing head 102 includes a plurality of heat generating elements whose heat generation is configured to be controlled independently of each other.

(Platen Roller)

The platen roller 103 is positioned, inside the cassette accommodating portion 101, adjacent to the printing head 102 so as to face the printing head 102. The platen roller 103 is pivotally movable toward and away from the printing head 102. The platen roller 103 has a rotation axis L1 that is parallel to the up-down direction.

(Platen Gear)

The platen gear 104 is connected to the platen roller 103. In the present embodiment, the platen gear 104 has a rotation axis L2 that is coincident with the rotation axis L1 of the platen roller 103. The platen gear 104 is pivotally movable together with the platen roller 103.

(Drive Shaft)

The drive shaft 105 is configured to be inserted in a take-up spool 16 and an input gear 22 of the printing cassette 10. The drive shaft 105 is configured to input a driving force into the printing cassette 10 to rotate the take-up spool 16 and the input gear 22.

The drive shaft 105 is positioned inside the cassette accommodating portion 101. The drive shaft 105 has a rotation axis L3 that is parallel to the up-down direction. The drive shaft 105 is rotatable about its rotation axis L3 by the drive source 107.

(Driving Source)

The drive source 107 is configured to drivingly rotate the drive shaft 105. As the drive source 107, a mechanism combining a motor and a gear is available, for example.

<Printing Cassette>

The printing cassette 10 stores therein the printing tape 11A. The printing cassette 10 is attachable to and detachable from the printer body 100. By replacing the printing cassette 10, replenishment of a printing medium and change of a kind (for example, size, color, and material, etc.) of the printing medium can be performed.

As illustrated in FIGS. 2A, 2B and 2C, the printing cassette 10 includes the case 35 that accommodates therein at least a part of the printing tape 11A and at least a part of an ink ribbon 14A (as an example of an auxiliary tape).

An outer shape of the printing cassette 10 (that is, the outer shape of the case 35) is a rectangular parallelepiped shape having sides parallel to the up-down direction, another sides parallel to the front-rear direction, and still another sides parallel to the left-right direction. The case 35 can be inserted downward into the cassette accommodating portion 101.

As illustrated in FIG. 3, the printing cassette 10 includes a printing tape roll 11, a first supply spool 12, spacer films 13A, 13B, an auxiliary tape roll 14, a second supply spool 15, the take-up spool 16, a clutch spring holder 17, and a power transmission mechanism 20.

(Printing Tape Roll)

The printing tape roll 11 is configured by winding the printing tape 11A over the first supply spool 12. On a surface of the printing tape 11A, printing is performed by the printing head 102 of the printer body 100 and the ink ribbon 14A.

The two spacer films 13A and 13B are positioned on both outer sides in the up-down direction of the printing tape roll 11 such that the spacer films 13A and 13B nip the printing tape roll 11 therebetween. The spacer film 13A is positioned between the printing tape roll 11 and a first cover part 31, and the spacer film 13B is positioned between the printing tape roll 11 and a first frame part 32.

(First Supply Spool)

The first supply spool 12 is rotatable about its rotation axis L4 parallel to the up-down direction. The first supply spool 12 is configured to rotate in accordance with conveyance of the printing tape 11 by the platen roller 103 of the printer body 100, thereby supplying the printing tape 11A to the printing head 102. The rotation axis L4 of the first supply spool 12 is coincident with an axis of winding of the printing tape roll 11.

(Auxiliary Tape Roll)

The auxiliary tape roll 14 is configured by winding the ink ribbon 14A to be used for printing over the second supply spool 15.

The ink ribbon 14A is superposed with the printing tape 11A at a head opening 33B, and is then to be used for printing by the printing head 102. The ink ribbon 14A used for printing is then configured to be taken-up by the take-up spool 16.

To the auxiliary tape roll 14, a rotational resistance is imparted by a clutch spring 17A held by the clutch spring holder 17. At least a part of the auxiliary tape roll 14 is positioned to overlap with the printing tape roll 11 in the up-down direction.

(Second Supply Spool)

The second supply spool 15 is rotatable about its rotation axis L5. The rotation axis L5 of the second supply spool 15 is parallel to the up-down direction. The second supply spool 15 is configured to rotate in accordance with taking up of the ink ribbon 14A by the take-up spool 16, thereby supplying the ink ribbon 14A to the printing head 102.

(Take-Up Spool)

The take-up spool 16 is rotatable about its rotation axis L6. The rotation axis L6 of the take-up spool 16 is parallel to the rotation axis L5 of the second supply spool 15.

The take-up spool 16 has a hollow cylindrical shape, and has an inner peripheral surface 16A that defines a hollow part. The inner peripheral surface 16A of the take-up spool 16 is formed with spline teeth 16B. To the spline teeth 16B, the drive shaft 105 of the printer body 100 is configured to be connected. The take-up spool 16 is configured to be rotated by the drive shaft 105 to take up the ink ribbon 14A.

(Power Transmission Mechanism)

The power transmission mechanism 20 is configured to transmit the driving force of the drive source 107 from the drive shaft 105 to the platen roller 103 upon attachment of the printing cassette 10 to the printer body 100. The power transmission mechanism 20 includes the output gear 21, the input gear 22, and an idle gear 23.

As illustrated in FIG. 4, the printing tape roll 11, the power transmission mechanism 20, and the take-up spool 16 are arranged in the up-down direction in an order of the printing tape roll 11, the power transmission mechanism 20 and the take-up spool 16.

(Output Gear)

The output gear 21 illustrated in FIG. 3 is an externally toothed gear configured to output the driving force to an outside for conveying the printing tape 11A. Specifically, the output gear 21 is configured to transmit the driving force to the platen gear 104 of the printer body 100.

The output gear 21 has a rotation axis L7 that is parallel to the rotation axis L5 of the second supply spool 15. An entirety of the output gear 21 is overlapped with a partition wall 32B of the case 35 in the up-down direction. Further, the output gear 21 has a part that is exposed to a space in communication with the head opening 33B.

The output gear 21 is configured to mesh with the platen gear 106 at the space in communication with the head opening 33B upon attachment of the printing cassette 10 to the printer body 100 (that is, upon accommodation of the case 35 in the cassette accommodating portion 101).

(Input Gear)

The input gear 22 indirectly meshes with the output gear 21 through the idle gear 23 to transmit the driving force to the output gear 21.

The input gear 22 includes an external gear 22A, and a spool 22B which is a hollow cylindrical-shaped internal gear. The spool 22B is fixed to a surface of the external gear 22A and has spline teeth at an inner peripheral surface of the spool 22B. The external gear 22A is rotatable together with the spool 22B by the driving force of the drive source 107 inputted in the spool 22B.

The input gear 22 has a rotation axis L8 (that is, the rotation axes of the external gear 22A and the spool 22B) that is on the same line as the rotation axis L6 of the take-up spool 16. At least a part of the input gear 22 is positioned to overlap with the printing tape roll 11 in the up-down direction.

The rotation axis L8 of the input gear 22 is overlapped with the hollow part of the take-up spool 16 in the up-down direction. Hence, the drive shaft 105 penetrates through the take-up spool 16 and the input gear 22 at the same time in a state where the printing cassette 10 is attached to the printer body 100. As a result, the input gear 22 is rotatable together with the take-up spool 16 by the drive shaft 105, even though the input gear 22 is not directly connected to the take-up spool 16.

(Idle Gear)

The idle gear 23 is drivingly connected to the input gear 22 and the output gear 21 (that is, the idle gear idle gear 23 is meshingly engaged with the input gear 22 and the output gear 21) to transmit the driving force inputted in the input gear 22 to the output gear 21.

The idle gear 23 is a stepped gear configured of an upstream gear 23A, and a downstream gear 23B coaxially arranged with the upstream gear 23A. The upstream gear 23A is in meshing engagement with the input gear 22. The downstream gear 23B is in meshing engagement with the output gear 21. The downstream gear 23B has a smaller diameter than the upstream gear 23A. Further, the downstream gear 23B is positioned closer to the printing tape roll 11 in the up-down direction (i.e., above) than the upstream gear 23A is to the printing tape roll 11 in the up-down direction.

The idle gear 23 is configured to deceleratingly transmit the driving force inputted in the input gear 22 to the output gear 21. That is, the power transmission mechanism 20 includes a deceleration mechanism providing, as a reduction ratio, a transmission ratio obtained by dividing a rotation speed of the input gear 22 by a rotation speed of the output gear 21.

(Case)

The case 35 includes the first cover part 31, the first frame part 32, a second frame part 33, and a second cover part 34.

The first cover part 31 constitutes an upper end portion of the printing cassette 10. The first frame part 32 is positioned below the first cover part 31, and is connected to the first cover part 31 in the up-down direction. The second frame part 33 is positioned below the first frame part 32, and is connected to the first frame part 32 in the up-down direction. The second cover part 34 constitutes a lower end portion of the printing cassette 10. The second cover part 34 is connected to the second frame part 33 in the up-down direction.

The first cover part 31 and the first frame part 32 constitute in combination a roll case 41 for accommodating the printing tape roll 11 therein. That is, the printing tape roll 11 is positioned in a space defined by the first cover part 31 and the first frame part 32.

The second cover part 34 and the second frame part 33 constitute in combination a guide case 42 for accommodating therein the auxiliary tape roll 14, the second supply spool 15, and the take-up spool 16. That is, the auxiliary tape roll 14, the second supply spool 15, and the take-up spool 16 are positioned in a space defined by the second cover part 34 and the second frame part 33. The guide case 42 is at a position different from the position of the printing tape roll 11 (specifically, below) in the up-down direction.

The first frame part 32 and the second frame part 33 constitute in combination a gear case 43 for accommodating therein a part of the output gear 21, the input gear 22, and the idle gear 23. That is, the part of the output gear 21, the input gear 22, and the idle gear 23 are positioned in a space defined by the first frame part 32 and the second frame part 33. The gear case 43 is positioned between the roll case 41 and the guide case 42 in the up-down direction.

The first frame part 32 includes a first side wall 32A, the partition wall 32B, and a first guide 32C. The first side wall 32A constitutes an outer side surface of the case 35 that is parallel to the up-down direction. The partition wall 32B has a surface perpendicular to the up-down direction, and extends in the front-rear direction and in the left-right direction. The partition wall 32B is overlapped with the printing tape roll 11 and the power transmission mechanism 20 in the up-down direction.

As illustrated in FIG. 5, the first guide 32C is a portion along which the printing tape 11A paid out from the printing tape roll 11 is wound. The first guide 32C includes a plurality of plate-like ribs arranged to be spaced away from one another in a circumferential direction of the printing tape roll 11. The ribs protrude outward in a radial direction of the printing tape roll 11 such that a protruding amount of each rib (that is, a plate width) gradually increases toward the bottom.

The second frame part 33 illustrated in FIG. 3 includes a second side wall 33A, the head opening 33B, the discharge opening 33C, a wall section 33D, an arm portion 33E, a discharge portion 33F, a second guide 33G (an example of a guide portion), first through third pawls 33H, 33I, 33J (see FIGS. 2A and 2B), and first through third abutment portions 33K, 33L, 33M.

In the second frame part 33, at least the head opening 33B, the wall section 33D, the arm portion 33E, the discharge portion 33F, the second guide 33G, the first through third pawls 33H, 33I, 33J, and the first through third abutment portions 33K, 33L, 33M are positioned inside the guide case 42.

The second side wall 33A constitutes an outer side surface of the case 35 extending parallel to the up-down direction. The head opening 33B is a notched part of the second side wall 33A. The head opening 33B is a space in which the printing head 102 is arranged in the state where the printing cassette 10 is attached to the printer body 100.

In the head opening 33B, the printing head 102 performs printing on the printing tape 11A. The head opening 33B is open downward of the printing cassette 10 so that the printing head 102 can be inserted in the head opening 33B from below.

As illustrated in FIG. 6, the printing tape 11A and the ink ribbon 14A are arranged to extend in the left-right direction at the head opening 33B. The printing tape 11A is exposed to an outside of the case 35 and is superposed with the ink ribbon 14A at the head opening 33B. After being printed, the printed printing tape 11A is discharged to the outside of the printing device 1 through the discharge opening 33C.

The wall section 33D illustrated in FIG. 3 has a surface perpendicular to the up-down direction, and extends in the front-rear direction and the left-right direction. The wall section 33D has a first shaft portion 330 rotatably supporting the second supply spool 15, and a second shaft portion 33P rotatably supporting the take-up spool 16.

The arm portion 33E is configured to convey the printing tape 11A in the left-right direction at a position upstream of the head opening 33B and the discharge opening 33C in a discharging direction of the printing tape 11A. The arm portion 33E constitutes a tunnel surrounding the printing tape 11A in a widthwise direction thereof as well as in a thickness direction of the printing tape 11A.

The discharge portion 33F allows the printing tape 11A, which has moved past the arm portion 33E, to be discharged to the outside (specifically, to the space in communication with the head opening 33B). The discharge portion 33F constitutes an outlet of the arm portion 33E. The printing tape 11A discharged through the discharge portion 33F is then conveyed to the discharge opening 33C through the head opening 33B.

Similar to the first guide 32C, the second guide 33G is a portion along which the printing tape 11A paid out from the printing tape roll 11 is wound. The second guide 33G includes a plurality of plate-like ribs arranged to be spaced away from one another in a circumferential direction of the auxiliary tape roll 14. The ribs protrude outward in a radial direction of the auxiliary tape roll 14, and a protruding amount of each rib (i.e., a plate width) gradually decreases toward the bottom.

Each of the first pawl 33H, the second pawl 33I, and the third pawl 33J illustrated in FIGS. 2A, 2B and 2C protrudes outward from the second side wall 33A of the second frame part 33.

The first pawl 33H is positioned at a first side surface 42A of the guide case 42. The first side surface 42A is overlapped with the second guide 33G in a direction perpendicular to the center axis of the printing tape roll 11 (specifically, in the left-right direction). The first side surface 42A is perpendicular to the left-right direction and constitutes a right side surface of the guide case 42.

The first pawl 33H has a first engagement surface 331 engageable with the first engaging portion 101A of the printer body 100. The first engagement surface 331 is constituted by a region of the first pawl 33H that is configured to contact the first engaging portion 101A to restrict upward movement of the guide case 42 (i.e., detachment from the cassette accommodating portion 101).

The first engagement surface 331 extends to protrude outward (that is, rightward) of the guide case 42 from the first side surface 42A. The first engagement surface 331 is a flat plane perpendicular to the up-down direction, and crosses the first side surface 42A.

The second pawl 33I and the third pawl 33J are positioned at a second side surface 42B of the guide case 42. The second side surface 42B is overlapped with the second guide 33G in the direction perpendicular to the center axis of the printing tape roll 11 (specifically, in the left-right direction).

The second side surface 42B is perpendicular to the left-right direction and constitutes a left side surface of the guide case 42. At least a part of the second side surface 42B (in the present embodiment, an entirety of the second side surface 42B) is at the same position as the first side surface 42A in the up-down direction.

The first side surface 42A faces the second side surface 42B in the discharging direction of the printing tape 11A at the discharge portion 33F. Further, the first side surface 42A and the second side surface 42B are positioned to sandwich at least a part of the power transmission mechanism 20 therebetween in the left-right direction.

The second pawl 33I has a second engagement surface 332 engageable with the second engaging portion 101B of the printer body 100. The third pawl 33J has a third engagement surface 333 engageable with the third engaging portion 101C of the printer body 100. The second engagement surface 332 and the third engagement surface 333 are constituted by regions of the second pawl 33I and the third pawl 33J, respectively, the regions being configured to contact the second engaging portion 101B and the third engaging portion 101C, respectively, to restrict upward movement of the guide case 42.

The second engagement surface 332 and the third engagement surface 333 extend respectively to protrude outward (that is, leftward) of the guide case 42 from the second side surface 42B. The second engagement surface 332 and the third engagement surface 333 are flat planes perpendicular to the up-down direction, and respectively cross the second side surface 42B.

The first engagement surface 331, the second engagement surface 332, and the third engagement surface 333 face in a direction (upward) which is opposite to an advancing direction of the guide case 42 (i.e., downward) at the time of insertion of the guide case 42 into the cassette accommodating portion 101.

That is, as illustrated in FIG. 7, the first engagement surface 331 is configured to be overlapped with a pawl of the first engaging portion 101A from above. Similarly, the second engagement surface 332 and the third engagement surface 333 are configured to be overlapped with pawls of the second engaging portion 101B and the third engaging portion 101C from above. The first engagement surface 331, the second engagement surface 332 and the third engagement surface 333 are respectively perpendicular to the advancing direction of the guide case 42 at the time of insertion of the guide case 42 into the cassette accommodating portion 101.

Incidentally, the first engaging portion 101A, the second engaging portion 101B, and the third engaging portion 101C are respectively movable in the left-right direction. Upon insertion of the case 35 in the cassette accommodating portion 101, a locking state is provided for each engaging portion such that each engaging portion is engaged with each engagement surface. The locking state is released by moving each locking portion in a direction away from the case 35.

As illustrated in FIG. 4, at least a part of the first engagement surface 331 (in the present embodiment, an entirety of the first engagement surface 331) is at the same position as the second engagement surface 332 in the up-down direction. Further, at least a part of the second engagement surface 332 (in the present embodiment, an entirety of the second engagement surface 332) is at the same position as the third engagement surface 333.

The printing tape roll 11, the output gear 21, the first engagement surface 331, and the auxiliary tape roll 14 are arranged in the up-down direction in such an order of the printing tape roll 11, the output gear 21, the first engagement surface 331, and the auxiliary tape roll 14.

That is, the auxiliary tape roll 14 is positioned opposite the printing tape roll 11 and the output gear 21 with respect to the first engagement surface 331, the second engagement surface 332, and the third engagement surface 333 in the up-down direction.

Further, at least a part of the first engagement surface 331, at least a part of the second engagement surface 332, and at least a part of the third engagement surface 333 are respectively at the same position as the wall section 33D in the up-down direction. In other words, the first engagement surface 331, the second engagement surface 332, and the third engagement surface 333 are overlapped with the wall section 33D in the left-right direction.

As illustrated in FIG. 8, in the printing cassette 10, a first imaginary straight line S1 is defined, the first imaginary straight line S1 passing through the first engagement surface 331 and the second engagement surface 332 and overlapping with the printing tape roll 11 as viewed in the up-down direction. The first imaginary straight line S1 is also overlapped with the auxiliary tape roll 14 as viewed in the up-down direction.

Further, a second imaginary straight line S2 is defined in the printing cassette 10, the second imaginary straight line S2 passing through a geometric centroid G1 of the first engagement surface 331 and a geometric centroid G2 of the second engagement surface 332 and overlapping with the printing tape roll 11 as viewed in the up-down direction.

The first abutment portion 33K, the second abutment portion 33L, and the third abutment portion 33M respectively abut on the printer body 100 in the up-down direction upon insertion of the guide case 42 in the cassette accommodating portion 101.

The first abutment portion 33K, the second abutment portion 33L, and the third abutment portion 33M are configured to make contact with corresponding portions of the printer body 100 from above, thereby providing positioning of the case 35 in the up-down direction relative to the cassette accommodating portion 101.

The first abutment portion 33K, the second abutment portion 33L, and the third abutment portion 33M are positioned to be spaced apart from one another. Further, when viewed in the up-down direction, a direction in which the first abutment portion 33K and the second abutment portion 33L are spaced apart from each other is different from a direction in which the second abutment portion 33L and the third abutment portion 33M are spaced apart from each other.

That is, as viewed in the up-down direction, the first abutment portion 33K, the second abutment portion 33L, and the third abutment portion 33M are not arranged linearly. In other words, there is no imaginary straight line that can pass simultaneously through the first abutment portion 33K, the second abutment portion 33L, and the third abutment portion 33M.

The first abutment portion 33K is positioned to overlap with the head opening 33B in the up-down direction. Specifically, the first abutment portion 33K is positioned above the head opening 33B. The first abutment portion 33K is exposed toward the bottom of the printing cassette 10 through the head opening 33B. The first abutment portion 33K is configured to abut on the printing head 102 that is inserted in the head opening 33B.

The second abutment portion 33L is positioned at a corner portion of the second frame part 33 as viewed in the up-down direction. Specifically, the second abutment portion 33L is constituted by a bottom surface of a hollow cylindrical body positioned at a left-front corner portion of the second frame part 33, the hollow cylindrical body having a center axis parallel to the up-down direction.

The second abutment portion 33L is a bottom surface of a recessed portion which is a part of the second frame part 33 and which is recessed upward. Into the hollow cylindrical body constituting the second abutment portion 33L, a part extending in the up-down direction inside the cassette accommodating portion 101 (for example a pin) is configured to be inserted.

When viewed in the up-down direction, the bottom surface of the recessed portion constituting the second abutment portion 33L extends in a direction perpendicular to the up-down direction. Specifically, the extending direction of the bottom surface of the recessed portion crosses both of the discharging direction of the printing tape 11A at the discharge opening 33C (that is, the left-right direction) and the front-rear direction. More specifically, the bottom surface of the recessed portion extends toward the rotation axis L8 of the input gear 22, and the extending direction of the bottom surface of the recessed portion is perpendicular to a circumferential direction of a circle centered on the rotation axis L8 of the input gear 22.

An inner peripheral surface of the hollow cylindrical body (that is, an inner side surface of the recessed portion) constituting the second abutment portion 33L allows the pin inserted in the hollow cylindrical body to move in a direction crossing the left-right direction and the front-rear direction, but restricts the pin from pivotally moving about the rotation axis L8 of the input gear 22. That is, the inner side surface of the recessed portion restricts the case 35 from rotating about the rotation axis L3 of the drive shaft 105.

The third abutment portion 33M is arranged to be connected to an outer side surface of the second frame part 33 which is parallel to the up-down direction (specifically, a part of a rear side surface of the case 35). The third abutment portion 33M is constituted by a recessed portion formed in the rear side surface of the case 35.

Further, the third abutment portion 33M is at a position different from the position of the bottom surface of the case 35 in the up-down direction (i.e., above the bottom surface). The third abutment portion 33M is configured to abut on an upper end of a part protruding in the up-down direction (for example, a rib) inside the cassette accommodating portion 101.

In the printing cassette 10, an imaginary triangle T is defined as viewed in the up-down direction. The imaginary triangle T is defined by three vertexes positioned within the first abutment portion 33K, the second abutment portion 33L, and the third abutment portion 33M, respectively. The imaginary triangle T is overlapped with the first imaginary straight line S1. Further, the imaginary triangle T defines a center of gravity G3 that is positioned on the first imaginary straight line S1 as viewed in the up-down direction.

As illustrated in FIGS. 9A, 9B, 9C and 9D, the first guide 32C and the second guide 33G define a pathway for conveying the printing tape 11A constituting the printing tape roll 11 from the roll case 41 to the guide case 42.

Specifically, as illustrated in FIG. 9A, the printing tape 11A paid out from the printing tape roll 11 is helically brought into contact with the first guide 32C from a radially outer side of the printing tape roll 11, so that the printing tape 11A is conveyed diagonally downward and rearward in the roll case 41. The printing tape 11A is further conveyed diagonally downward and leftward while straddling the gear case 43 in the up-down direction, as illustrated in FIG. 9B.

The printing tape 11A reaching the guide case 42 is brought into contact with the second guide 33G from a radially outer side thereof, so that the printing tape 11A is conveyed diagonally downward and frontward, as illustrated in FIG. 9C. The printing tape 11A reaching a lower end portion of the printing cassette 10 passes through the head opening 33B and is discharged rightward through the discharge opening 33C, as illustrated in FIG. 9D.

<Conveying Printing Tape and Printing on Printing Tape by Printer Body>

In the state where the printing cassette 10 is attached to the printer body 100, the printing head 102 is positioned, at the head opening 33B, to superpose with the printing tape 11A and the ink ribbon 14A in the front-rear direction.

The printing tape 11A is conveyed to the head opening 33B by the platen roller 103, and is pressed by the platen roller 103 through the ink ribbon 14A against the printing head 102 whose heat generating elements are heated. In this way, a part of ink on a surface of the ink ribbon 14A is transferred to the printing tape 11A, thereby printing letters and marks on the printing tape 11A.

The platen roller 103 conveys the printed printing tape 11A toward the outside of the printing cassette 10. The platen roller 103 is rotated by the platen gear 104 engaged with the output gear 21. The platen roller 103 and the platen gear 104 are pivotally movable between a position away from the printing cassette 10 and a position illustrated in FIG. 10 where the platen gear 104 is engaged with the output gear 21.

In a state where the case 35 of the printing cassette 10 is accommodated in the cassette accommodating portion 101, the drive shaft 105 is engaged with the input gear 22, and the platen gear 104 is engaged with the output gear 21.

Specifically, in a state where the drive shaft 105 is inserted in the take-up spool 16 and the input gear 22, the platen roller 103 and the platen gear 104 pivotally move toward the head opening 33B of the printing cassette 10 to bring the platen gear 104 into engagement with the output gear 21.

In the state where the printing cassette 10 is attached, the drive shaft 105 rotates the input gear 22 which in turn rotates the output gear 21. Further, the rotation of the output gear 21 rotates the platen gear 104, thereby rotating the platen roller 103.

[1-2. Technical Advantages]

The following technical advantages can be obtained according to the above-described embodiment.

(1a) The first engagement surface 331, the second engagement surface 332, and the third engagement surface 333 are arranged to be offset from the printing tape roll 11 in the axial direction of the printing tape roll 11. With this structure, the arrangement of the first engagement surface 331, the second engagement surface 332, and the third engagement surface 333 is less likely to hamper a degree of freedom in designing the size of the guide case 42. As a result, an increase in size of the printing cassette 10 can be restrained.

(1b) Positional displacement of the printing tape roll 11 relative to the printer body 100 can be restrained, due to the existence of the first imaginary straight line S1 passing through the first engagement surface 331 and the second engagement surface 332 and overlapped with the printing tape roll 11 as viewed in the up-down direction.

(1c) Due to the existence of the second imaginary straight line S2 passing through the geometric centroid G1 of the first engagement surface 331 and the geometric centroid G2 of the second engagement surface 332 and overlapping with the printing tape roll 11 as viewed in the up-down direction, an inhibitory effect against displacement of the printing tape roll 11 relative to the printer body 100 can further be promoted.

(1d) The inhibitory effect against displacement of the auxiliary tape roll 14 relative to the printer body 100 can further be promoted, since the first imaginary straight line S1 is overlapped with the auxiliary tape roll 14 as viewed in the up-down direction.

(1e) Enhanced accuracy in positioning of the printing cassette 10 can be attained, due to the provision of the imaginary triangle T having three vertexes positioned respectively within the first abutment portion 33K, the second abutment portion 33L, and the third abutment portion 33M, and overlapped with the first imaginary straight line S1.

(1f) The enhanced accuracy in positioning of the printing cassette 10 can further be promoted, since the center of gravity G3 of the imaginary triangle T is overlapped with the first imaginary straight line S1 as viewed in the up-down direction.

(1g) Enhanced accuracy in positioning of the printing cassette 10 can be obtained, since the first side surface 42A having the first engagement surface 331 faces the second side surface 42B having the second engagement surface 332 in the discharging direction of the printing tape 11A at the discharge portion 33F.

(1h) Since at least a part of the first engagement surface 331 is at the same position as the second engagement surface 332 in the up-down direction, tilting of the printing cassette 10 can be restrained.

(1i) Enhanced accuracy in positioning of the printing cassette 10 can be achieved, since the third engagement surface 333 is provided at the second side surface 42B.

(1j) The first engaging portion 101A can have a simple configuration, since the first engagement surface 331 protrudes outward of the guide case 42 from the first side surface 42A.

(1k) Enhanced accuracy in positioning of the printing tape roll 11 and the auxiliary tape roll 14 can be obtained, since the first engagement surface 331 is arranged between the printing tape roll 11 and the auxiliary tape roll 14 in the up-down direction.

(1l) The engagement structure between the guide case 42 and the first engaging portion 101A can be simplified, since the first engagement surface 331 faces upward.

(1m) Since the first engagement surface 331 is the flat plane extending perpendicular to the up-down direction, the structure for engagement with the first engaging portion 101A can be simplified.

(1n) Since at least a part of the first engagement surface 331 is at the same position as the wall section 33D in the up-down direction, the respective center axes of the auxiliary tape roll 14 and the take-up spool 16 are restrained from getting inclined.

### 2. Other Embodiments

While the embodiments according to the present disclosure have been described, it goes without saying that the present disclosure is not limited to the above-described embodiments and various configurations can be made thereto.

(2a) The printing device according to the above-described embodiments need not be such a device using an ink ribbon for printing. For example, the printing device may perform printing on a strip-like heat sensitive paper. That is, the printing cassette does not necessarily include an ink ribbon.

Further, the printing device may use, as a printing tape, a stencil tape which is to be perforated to form a printing pattern by a thermal head. In a case that the stencil tape is employed as the printing tape, a lined paper tape is used as the auxiliary tape in place of the ink ribbon for protecting the stencil tape.

(2b) The printing cassette according to the above-described embodiments may not include a roll case. That is, the printing tape roll is not necessarily accommodated in the case.

(2c) In the printing cassette according to the above-described embodiments, the guide case may not include the second engagement surface and the third engagement surface. Alternatively, the guide case may have four or more engagement surfaces.

(2d) In the printing cassette according to the above-described embodiments, the power transmission mechanism may be positioned above the printing tape roll or below the first engagement surface. Alternatively, the printing cassette may not necessarily include the power transmission mechanism.

(2e) The function(s) exhibited by a single component in the above-described embodiments may be exhibited by a plurality of components in a sharing manner, or the function(s) exhibited by a plurality of components in the above-described embodiments may be exhibited by a single component in an integrated manner. Further, the component in the above-described embodiments may be partly omitted. Still further, at least a part of the structure of the above-described embodiments may be added to or replaced with other configuration(s) of the embodiments. Incidentally, each and every aspect encompassed by the technological concept specified by the recitation of the claims are within the meaning of the embodiment of the present disclosure.

What is claimed is:

1. A printing cassette attachable to a printer body including a cassette accommodating portion provided with a first engaging portion, the printing cassette comprising:
a printing tape roll configured of a printing tape; and
a guide case arranged at a position different from a position of the printing tape roll in a first direction parallel to an axial direction of the printing tape roll, the guide case having:
a guide portion configured to guide the printing tape paid out from the printing tape roll;
a first side surface overlapped with the guide portion in a direction perpendicular to the first direction; and
a first engagement surface engageable with the first engaging portion, the first engagement surface extending from the first side surface and crossing the first side surface.

2. The printing cassette according to claim 1,
wherein the cassette accommodating portion is further provided with a second engaging portion,
wherein the guide case further has:
a second side surface overlapped with the guide portion in the direction perpendicular to the first direction; and
a second engagement surface engageable with the second engaging portion,
wherein at least a part of the second side surface is at a position the same as a position of the first side surface in the first direction, and
wherein the second engagement surface extends from the second side surface and crosses the second side surface.

3. The printing cassette according to claim 2,
wherein a first imaginary straight line is defined in the printing cassette, the first imaginary straight line passing through the first engagement surface and the second engagement surface and being overlapped with the printing tape roll as viewed in the first direction.

4. The printing cassette according to claim 3,
wherein a second imaginary straight line is defined in the printing cassette, the second imaginary straight line passing through a geometric centroid of the first engagement surface and a geometric centroid of the second engagement surface and being overlapped with the printing tape roll as viewed in the first direction.

5. The printing cassette according to claim 3, further comprising an auxiliary tape roll configured of an auxiliary tape to be used for printing on the printing tape,
wherein the auxiliary tape roll is accommodated in the guide case, and
wherein the first imaginary straight line is overlapped with the auxiliary tape roll as viewed in the first direction.

6. The printing cassette according to claim 3,
wherein the guide case further comprises a first abutment portion, a second abutment portion, and a third abutment portion each configured to abut on the printer body in the first direction in a state where the guide case is accommodated in the cassette accommodating portion,
wherein the first abutment portion, the second abutment portion, and the third abutment portion are positioned to be spaced away from each other, and
wherein an imaginary triangle is defined in the printing cassette, the imaginary triangle being defined by three vertexes included respectively in the first abutment portion, the second abutment portion, and the third abutment portion and being overlapped with the first imaginary straight line as viewed in the first direction.

7. The printing cassette according to claim 6,
wherein the imaginary triangle has a center of gravity that is overlapped with the first imaginary straight line as viewed in the first direction.

8. The printing cassette according to claim 2,
wherein the guide case further comprises a discharge portion through which the printing tape is to be discharged to an outside of the guide case, and
wherein the first side surface faces the second side surface in a discharging direction of the printing tape at the discharge portion.

9. The printing cassette according to claim 2,
wherein at least a part of the first engagement surface is at a position the same as the position of the second engagement surface in the first direction.

10. The printing cassette according to claim 2,
wherein the cassette accommodating portion is further provided with a third engaging portion,
wherein the guide case further has a third engagement surface engageable with the third engaging portion, and
wherein the third engagement surface extends from the second side surface and crosses the second side surface.

11. The printing cassette according to claim 1,
wherein the first engagement surface protrudes outward of the guide case from the first side surface.

12. The printing cassette according to claim 1, further comprising an auxiliary tape roll configured of an auxiliary tape to be used for printing on the printing tape,
wherein the auxiliary tape roll is accommodated in the guide case, and
wherein the printing tape roll, the first engagement surface, and the auxiliary tape roll are arranged in the first direction in an order of the printing tape roll, the first engagement surface, and the auxiliary tape roll.

13. The printing cassette according to claim 1,
wherein the first engagement surface faces in a direction opposite a direction of insertion of the guide case into the cassette accommodating portion.

14. The printing cassette according to claim 13,
wherein the first engagement surface is a flat plane perpendicular to the direction of insertion.

15. The printing cassette according to claim 1, further comprising:
an auxiliary tape roll configured of an auxiliary tape to be used for printing on the printing tape; and
a spool over which the auxiliary tape is to be wound,
wherein the auxiliary tape roll and the spool are accommodated in the guide case,
wherein the guide case comprises a wall section rotatably supporting the spool, and
wherein at least a part of the first engagement surface is at a position the same as a position of the wall section in the first direction.

16. A printing device comprising:
a printer body comprising a cassette accommodating portion provided with a first engaging portion; and
the printing cassette according to claim 1.
